(19) United States
(12) Patent Application Publication
(10) Pub. No.: US 2018/0016443 A1
(43) Pub. Date: Jan. 18, 2018

(54) ANTICORROSION COMPOSITION, AN ANTICORROSION FILM, AND A METHOD OF FORMING THE SAME

(71) Applicant: Jordan University of Science and Technology, Irbid (JO)

(72) Inventors: Mohammad Mousa Fares, New Zarqa (JO); Khansa'a Hasan Masadeh, Irbid (JO)

(21) Appl. No.: 15/210,621

(22) Filed: Jul. 14, 2016

(51) Int. Cl. C09D 5/08

(52) U.S. Cl. CPC C09D 5/086

(57) ABSTRACT

An anticorrosion composition and an anticorrosion film formed by a micro-assembled glutamine-reinforced silica gel monolayer or multilayers of such monolayers applied to a substrate surface, and a method of formation thereof are disclosed. The anticorrosion compositions may include a range of about 29.0%-48.0% by weight silica (SiO₂), about 19.0%-50.0% by weight glutamine amino acid, about 14.0%-24.0% by weight glyceryl linkage, and about 5.0%-10.0% by weight calcium ions.

### TECHNICAL FIELD

The present disclosure relates to an anticorrosion film composition, an anticorrosion film, and a method of forming the same, wherein the film includes micro-assembled glutamine-reinforced silica gel monolayer or multilayers of such monolayers.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Corrosion can be defined as the degradation of a material due to a reaction with its environment. Degradation implies a deterioration of physical properties of the material. This can be a weakening of the material due to a loss of a cross-sectional area or portion of the material.

Such materials can be metals, polymers (for example, plastics, rubbers, etc.), ceramics (for example, concrete, brick, etc.), or composites-mechanical mixtures of two or more such materials possessing different properties.

Metals corrode as they are used in environments where they are chemically unstable. Only copper and precious metals (for example, gold, silver, platinum, etc.) are found in nature in their metallic state. All other metals are processed from minerals or ores into metals that are inherently unstable in their environments.

In spite of much advancement in the field of corrosion science and technology, the phenomenon of corrosion (mainly of Al, Cu, Zn, Mg, Fe, and their alloys) remains a major concern to industries around the world. Though the serious consequences of corrosion can be controlled to a great extent by selection and incorporation of highly corrosion resistant materials, the increased cost factor associated with the same favors the use of cheap metallic materials along with efficient corrosion prevention methods in many industrial applications.

In this aspect, corrosion inhibitors have ample significance as individual inhibitors or as a component in chemical formulations. They have wide commercial applications such as in cooling waters, oil and gas fields, paints, pigments, lubricants, etc.

Corrosion can pose serious problems to the safe and economic operation of a wide variety of industrial installations. The effects of corrosion in our daily lives are both direct, in that corrosion affects the useful service lives of our possessions, and indirect, in that producers and suppliers of goods and services incur corrosion inhibiting related costs, which they pass on to consumers.

A large number of corrosion inhibitors have been developed and used for application to various systems depending on the medium treated, the type of surface that is susceptible to corrosion, the type of corrosion encountered, and the conditions to which the medium is exposed.

In spite of the long history of corrosion inhibition efforts, a highly efficient and durable inhibitor that can offer complete (or at least a greater) protection in aggressive environments (such as a high Cl⁻ electrolyte) for longer duration has yet to be realized.

### SUMMARY

Aspects of the present disclosure provide an anticorrosion composition that includes an amino acid, a silica gel, a glyceryl linkage, and a multivalent cation ionic linkage, wherein the amino acid binds onto a surface of the substrate, the glyceryl linkage binds the hydroxyl groups of different silica gel particles together forming a silica gel cluster, the glyceryl linkage chemically binds carboxyl groups of the amino acid with hydroxyl groups of the silica gel cluster, and the cation physically binds carboxyl groups of the amino acid with hydroxyl groups of the silica gel cluster through ionic bonding.

In aspects of the present disclosure, the amino acid may include glutamine. Within aspects of the present disclosure, the composition may contain about 19.0%-50.0% by weight glutamine.

Within aspects of the present disclosure, the composition may contain about 29.0%-48.0% by weight silica gel.

Within aspects of the present disclosure, the composition may contain about 14.0%-24.0% by weight glyceryl linkage.

Within aspects of the present disclosure, the multivalent cation ionic linkage may be ionic calcium.

Within aspects of the present disclosure, the composition may contain about 5.0%-10.0% by weight ionic calcium (Ca⁺⁺).

Aspects of the present disclosure provide an anticorrosion film including a monolayer or multilayers (for example, multiple layers of such a monolayer) of an anticorrosion composition applied to a substrate surface.

In aspects of the present disclosure, during the formation of multilayers, amine groups of the amino acid bind to hydroxyl groups of the silica gel cluster of a previously formed layer through hydrogen bonding interactions.

In accordance with aspects of the present disclosure, the substrate surface may be a metal surface.

Aspects of the present disclosure provide a method of forming an anticorrosion film, the method including activating a substrate surface, forming a zwitterion layer on said substrate surface, preparing a synthesized reinforced silica gel solution, and covering the zwitterion layer with the synthesized reinforced silica gel solution while adding calcium ions as a crosslinking agent.

In aspects of the present disclosure, the activation is performed by maintaining substrate sheets in a basic aqueous solution for about 20 minutes.

According to aspects of the present disclosure, the aqueous solution may have a pH of about 10.

In accordance with aspects of the present disclosure, the formation of the zwitterion layer may include dissolving about 50 mg of glutamine amino acid in about 100 ml distilled water, adjusting the pH of the water-glutamine solution to a pH of about 8.5, and soaking the substrate-activated sheets in a water-glutamine solution with an adjusted pH for about 20 minutes.

In aspects of the present disclosure, preparation of the synthesized reinforced silica gel solution may include dissolving a specific amount of silica gel solution in about 100 ml aqueous solution having a pH of about 12.5 to prepare a basic solution, adjusting the pH of the prepared solution to about 10, dissolving about 60 mg glyceryl linkage in the prepared solution and stirring for about 30 minutes, and dissolving about 24 mg of CaCl₂ in the solution containing the glyceryl linkage.

In accordance with aspects of the present disclosure, the basic solution may include a silica gel concentration ranging between about 300 ppm to 1200 ppm.

### BRIEF DESCRIPTION OF THE DRAWINGS

FIG. 1A illustrates a graph showing a change of inhibition efficiency of a monolayer of an anticorrosive film, configured in accordance with embodiments of the present disclosure, covering a substrate surface, wherein the film contains different concentrations of silica gel in the film applied to the substrate surface.

FIG. 1B illustrates a graph showing a change of normalized weight loss of a substrate surface covered by a monolayer of an anticorrosive film, configured in accordance with embodiments of the present disclosure, with different concentrations of silica gel in the monolayer applied to the substrate surface.

FIG. 2A shows a scanning electron microscope (“SEM”) image of a surface of an aluminum substrate soaked in (exposed to) a 1.0 M HCl solution, wherein the exposure time is about one hour.

FIG. 2B shows a SEM image of a surface of an aluminum substrate soaked in a reinforced silica gel monolayer solution of about 1200 ppm, configured in accordance with embodiments of the present disclosure, wherein the exposure time is about one hour.

FIG. 2C shows a SEM image of a surface of an aluminum substrate exposed to about a 1.0 M HCl solution in a presence of about a 900 ppm reinforced silica gel monolayer solution, configured in accordance with embodiments of the present disclosure, wherein the exposure time is about one hour.

FIG. 2D shows a SEM image of an aluminum surface exposed to about a 1.0 M HCl solution in a presence of about a 1200 ppm reinforced silica gel monolayer solution, configured in accordance with embodiments of the present disclosure, wherein the exposure time is about one hour.

FIG. 3 illustrates a graph showing a change of inhibition efficiency of a formed bilayer versus reinforced silica gel bilayer concentration, wherein the bilayer is formed by two layers of silica gel applied on an aluminum surface.

FIG. 4A shows a SEM image of a bilayer of glutamine-reinforced silica gel solution on an aluminum surface after having been exposed to about 1.0 M HCl for about one hour.

FIG. 4B shows a SEM image of the bilayer on an aluminum surface after having been exposed to about 1.0 M HCl for about 6 hours.

FIG. 4C shows a SEM image of the bilayer on an aluminum surface after having been exposed to about 1.0 M HCl for about 12 hours.

FIG. 4D shows a SEM image of the bilayer on an aluminum surface after having been exposed to about 1.0 M HCl for about 24 hours.

FIG. 4E shows a SEM image of the bilayer on an aluminum surface after having been exposed to about 1.0 M HCl for about 48 hours.

FIG. 5A illustrates a graph showing Langmuir isotherm curves at different temperatures.

FIG. 5B illustrates a graph showing a change of equilibrium constant of adsorption with reciprocal temperature.

FIG. 6 illustrates a schematic of protolytic equilibrium of hydroxylated aluminum layer analogs.

FIG. 7 illustrates a schematic of glutamine layer formation over an aluminum surface.

FIG. 8 illustrates a schematic of formation of reinforced silica gel clusters.

FIG. 9 illustrates a schematic of building up of a glutamine-reinforced silica gel monolayer over an aluminum surface.

FIG. 10 illustrates a flow diagram of a process for making a film on a surface, configured in accordance with embodiments of the present invention.

### DETAILED DESCRIPTION

As described herein, the term “anticorrosion” (and similar terminology) refers to properties of a composition, film, and/or material that inhibits (resists) a formation of corrosion within a material. Similarly, the term “inhibition” (and similar terminology, such as “inhibition efficiency”) refers to the capability of a composition, film, and/or material to prevent, or otherwise resist, a formation of corrosion within a material.

Herein, by the term “multilayer,” it is meant two (for example, a bilayer) or more layers (for example, of the monolayers disclosed herein).

As used herein, the singular forms “a,” “an,” and “the” include the plural reference unless the context clearly indicates otherwise.

An aspect of the disclosure disclosed herein provides an anticorrosion composition, including about 19.0%-50.0% by weight glutamine amino acid, about 29.0%-48.0% by weight silica (SiO₂), about 14.0%-24.0% by weight glyceryl linkage, and about 5.0%-10.0% by weight ionic calcium (Ca⁺⁺).

Aspects of the disclosure provide an anticorrosion film including a composition of about 19.0%-50.0% by weight glutamine amino acid, about 29.0%-48.0% by weight silica (SiO₂), about 14.0%-24.0% by weight glyceryl linkage, and about 5.0%-10.0% by weight ionic calcium (Ca⁺⁺).

The film in accordance with embodiments of the present disclosure may be a monolayer or multilayers applied on a surface of a substrate, wherein such substrate may include a metal surface, such as aluminum.

In embodiments of the present disclosure, an amino acid binds onto the surface of a substrate, a glyceryl linkage binds the hydroxyl groups of different silica gel particles together forming a silica gel cluster, the glyceryl linkage chemically binds carboxyl groups of the amino acid with hydroxyl groups of the silica gel cluster, and a cation physically binds carboxyl groups of the amino acid with hydroxyl groups of the silica gel cluster through ionic bonding.

In embodiments of the present disclosure, during formation of multilayers, amine groups of the amino acid bind to hydroxyl groups of the silica gel cluster of a previously formed layer through hydrogen bonding interactions.

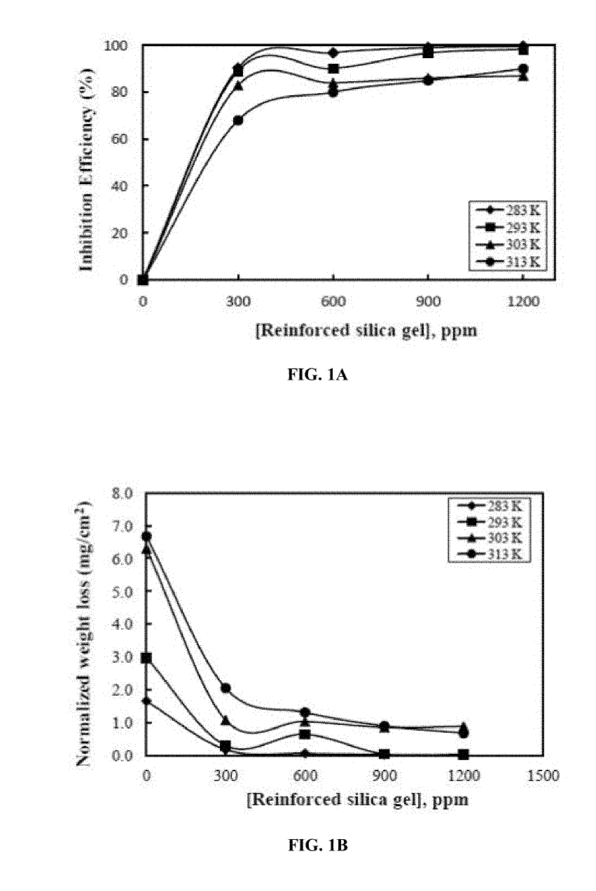

Reference is now being made to FIG. 1A, which depicts that the inhibition efficiency of a glutamine-reinforced silica gel monolayer, configured in accordance with embodiments of the present disclosure, covering a surface of a substrate increases exponentially at a high reinforced silica gel concentration and relatively low temperatures. Such inhibition increase denotes better-orientated monolayer constituents (i.e., zwitterion and reinforced silica gel layers) over the substrate surface, and describes successive building up layer-by-layer of an anticorrosive shield over the substrate surface, hence configuring the surface to resist severe corrosive environments for prolonged time periods.

FIG. 1B depicts that the weight loss of an exemplary aluminum substrate material covered by a glutamine-reinforced silica gel monolayer, configured in accordance with embodiments of the present disclosure, decreases exponentially at a high reinforced silica gel concentration and relatively low temperatures. Such a weight loss decrease results from an inhibition increase, thus denoting better-orientated monolayer constituents (i.e., zwitterion and reinforced silica gel layers) over the substrate surface, and describes successive building up layer-by-layer of an anticorrosive shield over the substrate surface, hence configuring the surface to resist corrosive environments for prolonged time periods.

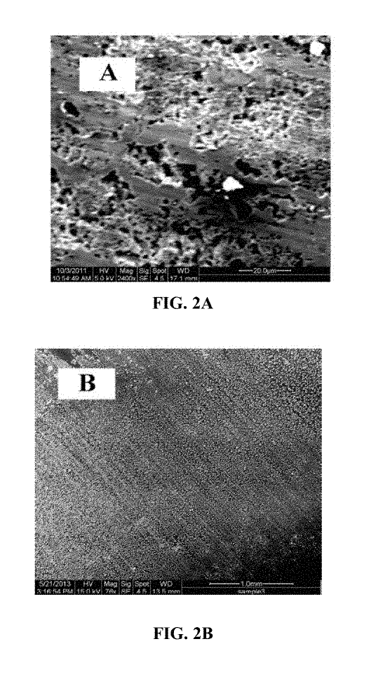

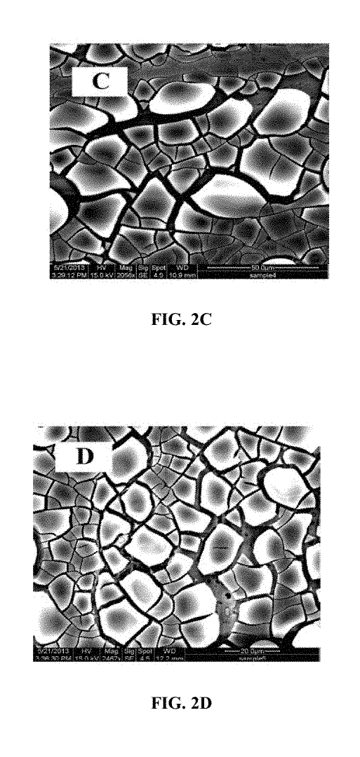

FIGS. 2A-2D show SEM images that describe the morphologic changes that occur on the aluminum surface before and after having been exposed to a corrosive HCl solution.

The kinetic parameters for a corrosion process were calculated to emphasize the successful monolayer inhibition process and properties described herein with respect to embodiments of the present disclosure. Activation energy, enthalpy of activation, and entropy of activation were calculated from linearized forms of the following relations:

$$\begin{matrix}{R}_{C} = A exp ( - \frac{{E}_{a}}{RT} ) & ( 1 ) \\ {R}_{C} = \frac{{k}_{b} T}{h} exp ( \frac{Δ {S}^{\neq }}{R} ) exp ( - \frac{Δ {H}^{\neq }}{RT} ) & ( 2 )\end{matrix}$$

wherein a rate of corrosion (R_{C}) is calculated as follows:

$${R}_{C} = \frac{W}{At} \qquad ( 3 )$$

and wherein W is the weight loss of aluminum, A is the surface area of the aluminum substrate, t is the exposure time, Eₐ is the activation energy, R is the universal gas constant that is equal to 0.082 atm.L/mol.K or 8.314 J/mol.K, T is experimental temperature, k_{b} is the Boltzmann constant, h is the Planck constant, ΔS^{≠} is the entropy of activation, and ΔH^{≠} is the enthalpy of activation.

Table 1 summarizes the calculated kinetic parameters. As the concentration of reinforced silica gel increases in the formed monolayer, higher activation energy, enthalpy, and entropy of activation are obtained. A three-fold increase of activation energy at about 1200 ppm was produced than at 0 ppm of reinforced silica gel, indicating an increased enhancement of cohesive and adhesive intermolecular forces, and hence an increase in the anticorrosive shielding effects of the formed monolayer, which came in accordance with inhibition efficiency values.

TABLE 1

| Reinforced silica | | Normalized | Rate of corrosion, |
|---|---|---|---|
| gel concentration | Temperature | weight loss | (R_{C}) × 10⁶ |
| (ppm) | (Kelvin) | (mg cm⁻²) | (mg cm⁻² s⁻¹) |
| 0 | 283 | 1.61 | 447 |
| | 293 | 2.89 | 802 |
| | 303 | 6.13 | 170 |
| | 313 | 6.50 | 181 |
| 300 | 283 | 0.167 | 46.3 |
| | 293 | 0.290 | 80.5 |
| | 303 | 1.04 | 289 |
| | 313 | 1.99 | 553 |
| 600 | 283 | 0.0527 | 14.6 |
| | 293 | 0.620 | 17.2 |
| | 303 | 1.00 | 27.8 |
| | 313 | 1.27 | 35.3 |
| 900 | 283 | 0.0208 | 5.77 |
| | 293 | 0.0361 | 10.0 |
| | 303 | 0.825 | 229 |
| | 313 | 0.868 | 241 |
| 1200 | 283 | 0.00555 | 1.54 |
| | 293 | 0.0306 | 8.50 |
| | 303 | 0.853 | 237 |
| | 313 | 0.653 | 181 |

The bilayer formation on the aluminum surface is meant to confirm and strengthen the firmness of the bilayer against a severe corrosive acidic environment for a prolonged time of exposure.

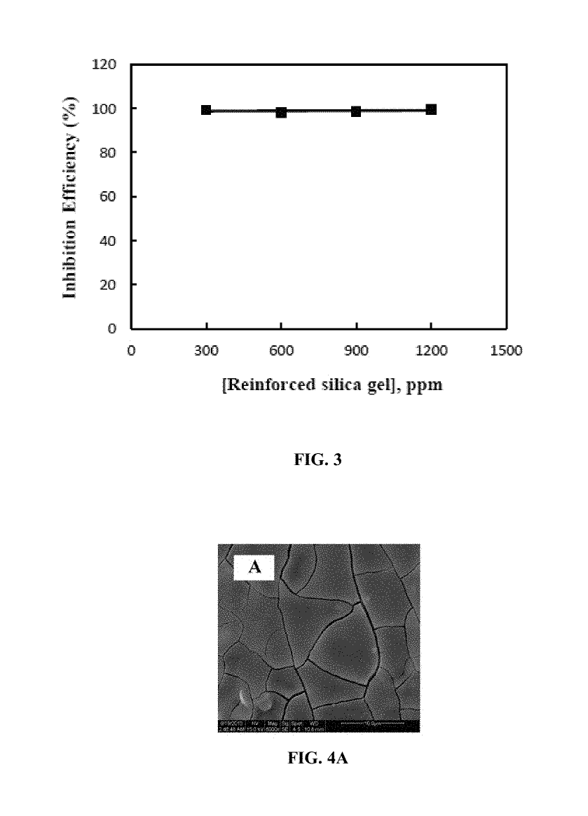

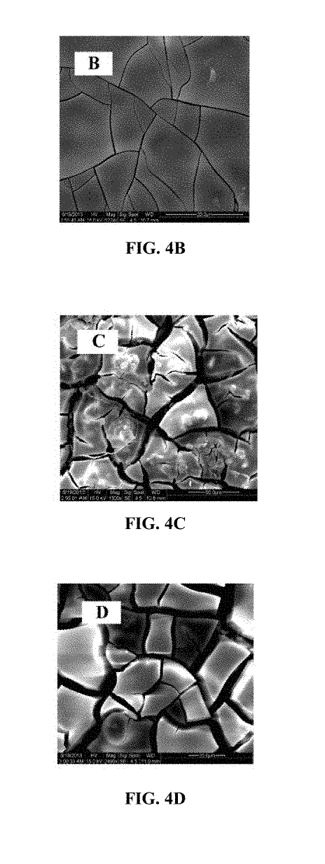

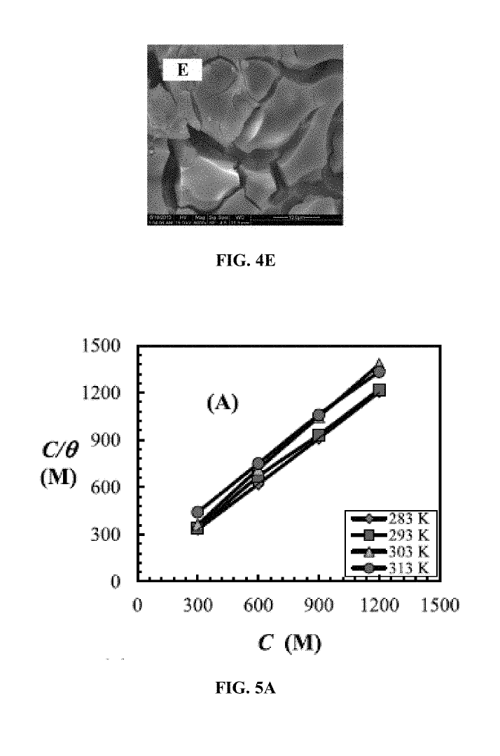

Referring now to FIG. 3, the shown inhibition efficiency values indicate that maximum inhibition (i.e., ≈100%) is obtained for all the reinforced silica gel concentrations of the formed bilayer. A similar inhibition efficiency can also be observed from the SEM images of FIGS. 4A-4E, as previously described in the Brief Description of the Drawings.

Thermodynamic parameters and adsorption isotherm were also calculated to confirm the successful adsorption and coverage of the monolayer on the substrate surface. Equilibrium constant of adsorption (K), standard free energy (ΔG°_{ads}), standard enthalpy (ΔH°_{ads}), and entropy of adsorption (ΔS°_{ads}) were calculated as follows:

Linearized form of Langmuir isotherm relates C/θ versus C as follows:

$$\frac{C}{θ} = \frac{1}{K} + C \qquad ( 5 )$$

wherein C is the concentration of reinforced silica gel solution, and θ is the fraction of surface covered and calculated from the inhibition efficiency:

Inhibition efficiency =θ×100 (6)

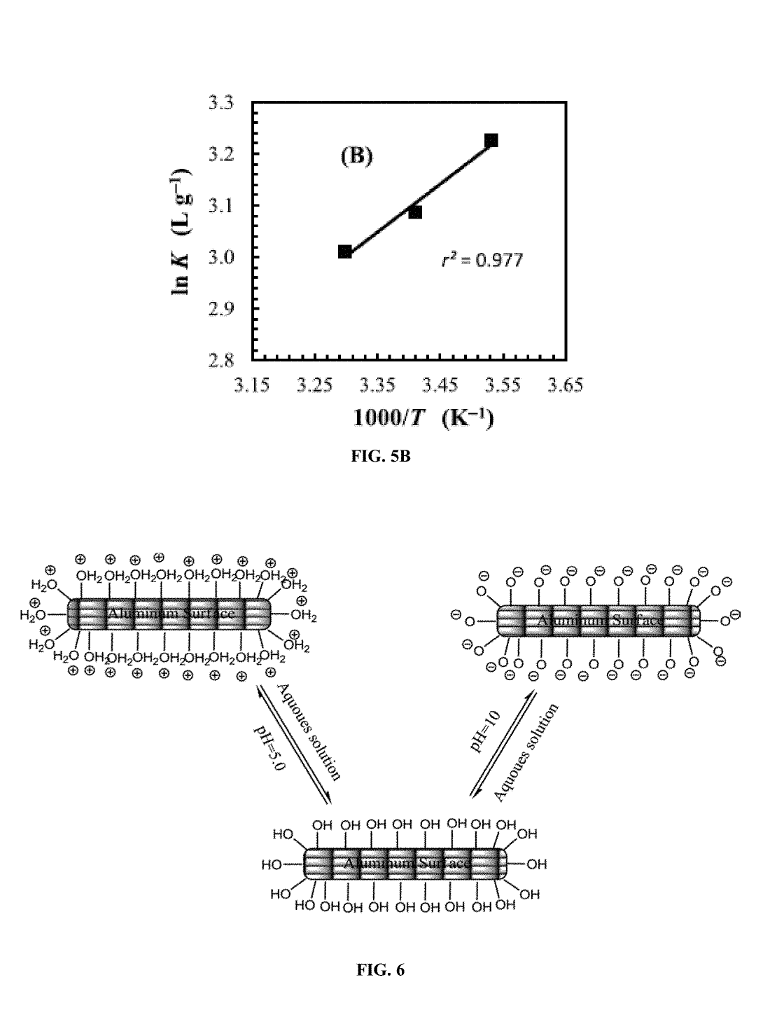

The equilibrium constant of adsorption (K) determined from Equation (5) at different temperatures is used in the following Equations 7-10 to determine the standard free energy (ΔG°_{ads}), standard enthalpy (ΔH°_{ads}), and entropy of adsorption (ΔS°_{ads}), respectively, as described in FIGS. 5A, 5B, and Table 2.

$$\begin{matrix}Δ {G}_{ads}^{°} = - RT ln ( 55.5 K ) & ( 7 ) \\ ln K = - \frac{Δ {H}_{ads}^{°}}{RT} + I & ( 8 ) \\ Δ {G}_{ads}^{°} = Δ {H}_{ads}^{°} - T Δ {S}_{ads}^{°} & ( 9 ) \\ ln K = - \frac{Δ {H}_{ads}^{°}}{RT} + ( \frac{Δ {S}_{ads}^{°}}{R} - ln 55.5 ) & ( 10 )\end{matrix}$$

TABLE 2

| Temperature | K | | ΔG° | ΔH° | ΔS° |
|---|---|---|---|---|---|
| (Kelvin) | (L g⁻¹) | r² | (kJ mol⁻¹) | (kJ mol⁻¹) | (J mol⁻¹ K⁻¹) |
| 283 | 25.2 | 1.00 | −23.9 | −7.74 | 56.9 |
| 293 | 21.9 | 0.989 | −24.4 | | 56.8 |
| 303 | 20.3 | 0.999 | −25.0 | | 56.9 |
| 313 | 6.7 | 0.999 | −22.9 | | 48.4 |

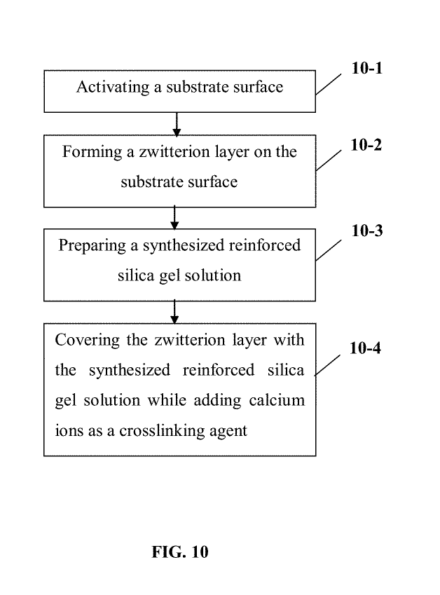

Referring to FIG. 10, which illustrates a flow diagram of a process for forming the aforementioned anticorrosion film on a surface of a substrate (for example, particularly metals), the method including (a) activating a substrate surface by maintaining sheets of the substrate in a basic aqueous solution (e.g., for about 20 minutes) (process block 10-1), (b) forming a zwitterion layer on the substrate surface (process block 10-2), (c) preparing a synthesized reinforced silica gel solution (process block 10-3), and (d) covering the zwitterion layer with the synthesized reinforced silica gel solution and substantially simultaneously adding calcium ions as a crosslinking agent (process bock 10-4).

In embodiments of the present disclosure, the substrate surface includes aluminum.

In embodiments of the present disclosure, the pH of the aqueous solution is about 10.

In embodiments of the present disclosure, the aforementioned steps (a)-(d) may be repeated more than one time to form a multilayer film on the surface of the substrate.

Reference is now being made to FIG. 6, which schematically illustrates how the aluminum oxide layer on the surface interacts with water to form a hydroxylated aluminum layer. The hydroxylated aluminum groups could be protonated or deprotonated depending on a selected pH value of the aqueous solution. Such protolytic equilibrium of hydroxylated aluminum can activate the aluminum surface with either positively or negatively charged ions. The zero charge potential for the resultant aluminum surface lies between a pH of 6 to 9. Therefore, at pH=10, the aluminum surface is activated with negatively charged ions (i.e., Al—O⁻), while at pH=5, the aluminum surface is activated with positively charged ions.

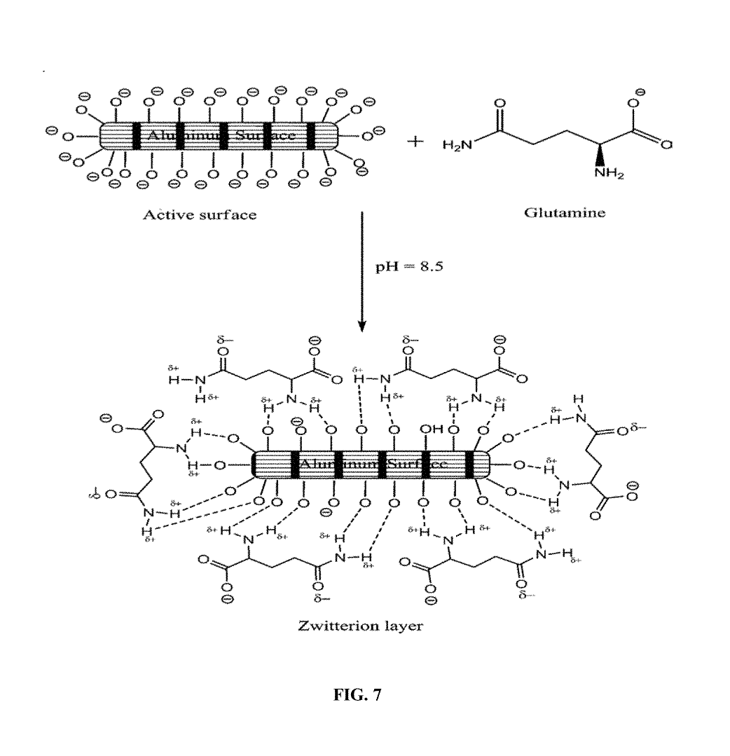

Referring to FIG. 7, the addition of a monolayer may be performed by (a) dissolving a glutamine amino acid (e.g., about 50 mg) in distilled water (e.g., about 100 ml) (Solution A), (b) adjusting the pH of the solution to a pH of about 8.5, and (c) soaking sheets of the substrate (e.g., aluminum with Al—O⁻ surface) in Solution A (e.g., for about 20 minutes).

FIG. 7 shows that the glutamine amino acid at a pH of about 8.5 is deprotonated from the carboxylic acid leading to a negative side of the carboxylate ion, and as a result a simultaneous attraction occurs of aluminum surface ions to the free partially positive hydrogen atoms of the amine groups in the glutamine, leading to the formation of a zwitterion layer over the substrate surface. Consequently, the negative side of the carboxylate ion of the glutamine will be oriented toward the solution.

Referring to FIG. 10, in embodiments of the present disclosure, the preparation of a reinforced silica gel solution may be performed by (a) dissolving an amount of silica hydrogel solutions in a basic aqueous solution (e.g., about 100 ml) at a pH of about 12.5 to prepare a solution with a concentration ranging between about 300 ppm and 1200 ppm, (b) adjusting the pH of the prepared solution in step (a) to about 10, (c) dissolving a glyceryl linkage coupling agent (e.g., about 60 mg) in the solution having an adjusted pH, and stirring (e.g., for about 30 minutes), (d) keeping the formed viscous reinforced silica gel solution in an inert environment until used (Solution C), and (e) dissolving CaCl₂ (e.g., about 24 mg) in Solution C. Step (d) may be optional.

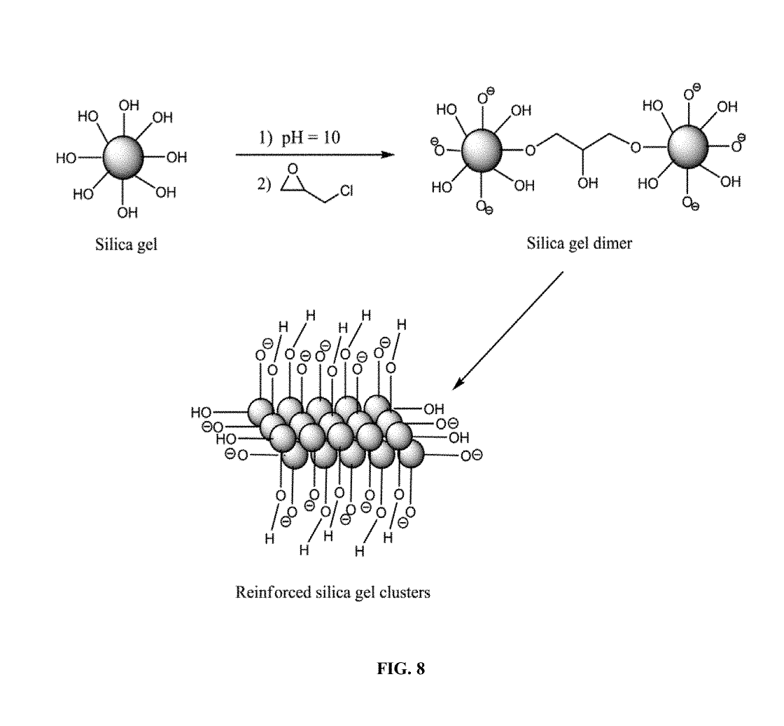

As depicted in FIG. 8, almost 50% of the silanol groups of the silica gel microspheres are deprotonated (pKₐ=9.84) at a pH of about 10, which can interact with a glyceryl linkage (C₃H₅ClO) to form a silica gel dimer. The coupling of silica gel microspheres into the growing chain continues irregularly until reinforced silica gel clusters are formed.

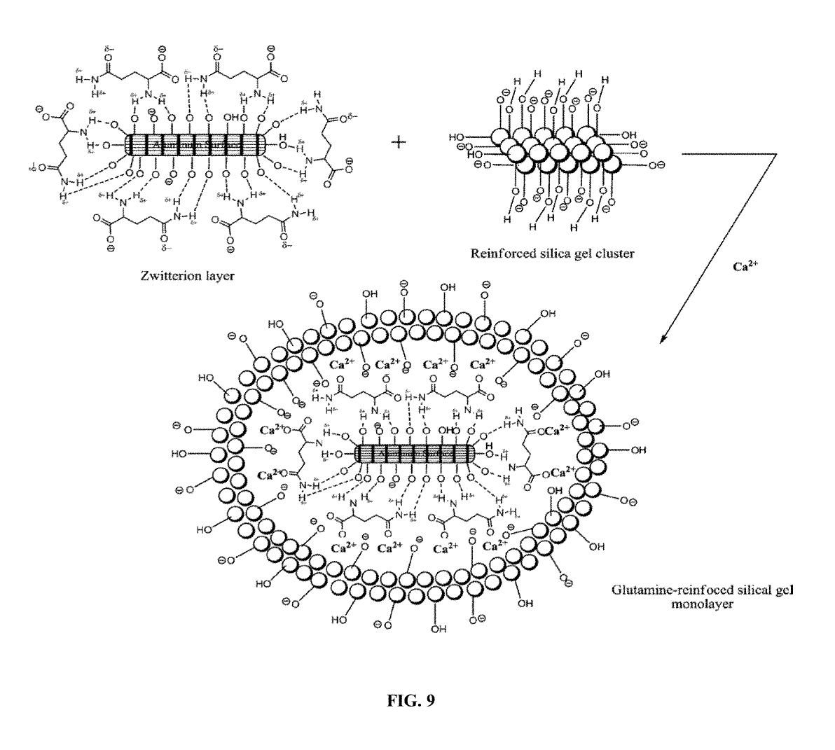

FIG. 9 is a schematic illustration that shows that the addition of a salt (e.g., calcium ions (Cₐ²⁺)) cross-linked the zwitterion layer with the free silica gel clusters and eventually formed a glutamine-reinforced silica gel monolayer over the substrate (e.g., aluminum) surface.

Embodiments of the present disclosure are further illustrated by the following examples, which are set forth to illustrate the presently disclosed subject matter and are not to be construed as limiting. The examples describe testing carried out to confirm the ability of embodiments of the present disclosure to provide an anticorrosive composition and film.

### EXAMPLES

### Example 1

### Monolayer Examination by Exposure to HCL

Monolayer thin film formation was examined by exposure to about a 1.0 M HCl solution for different time intervals from about 1 to 48 hours, and verified by inhibition efficiency and SEM surface morphology. The inhibition efficiency was calculated as follows:

$$Inhibition efficiency = \frac{{W}_{0} - {W}_{i}}{{W}_{0}} \times 100 \qquad ( 11 )$$

where W₀ and W₁ were the weight loss of aluminum in absence and in presence of anticorrosive monolayers, respectively. The surface morphology of the formed monolayer was studied using SEM imaging. The samples were mounted on specimen stabs, and coated with gold ions by a sputtering method to be imaged with a scanning electron microscope, such as the DSM 950 (ZEISS) model, Polaron (E6100) model.

The SEM images described the morphologic changes that occurred over the aluminum surface before and after having been exposed to a corrosive HCl solution.

Referring again to FIGS. 2A-2D, the SEM image in FIG. 2A shows the influence of molar HCl exposure on an uncovered aluminum surface. The aluminum surface was damaged and many corrosive punctures appeared all over the surface. The SEM image in FIG. 2B shows a glutamine-reinforced silica gel monolayer, configured in accordance with embodiments of the present disclosure, applied to the aluminum surface before being exposed to a corrosive HCl solution. Clearly, globular microspheres compacted and aligned near each other forming an anticorrosive shield monolayer against the corrosive environment.

The examination of monolayer firmness against a corrosive 1.0 M HCl environment for about one hour is shown in the SEM images of FIGS. 2C and 2D. The SEM images reveal longitudinal and cross-tearing cracks in the surface, and the formation of regular-sized micro-islands in the uniform monolayer. The tearing occurs in the weakest points of the monolayer structure as a result of an unsuccessful accumulation of the inhibitor on the aluminum surface. No complete disintegration of the anticorrosion film's monolayer was monitored, which reflects the consistency and the firmness of the formed monolayer against a severe acidic environment. The cross-torn cracks of the monolayer are about 1-2 μm in width, which are produced in accordance with a high inhibition efficiency as shown in FIG. 1 (i.e., inhibition efficiency=89%-96% at about 283 K).

### Example 2

### Bilayer Examination by Exposure to HCl

Bilayer thin film formation was also examined by exposure to about a 1.0 M HCl solution for different time intervals from about 1 to 48 hours, and verified by inhibition efficiency and SEM surface morphology. The inhibition efficiency was according to Equation (11) of Example 1.

Bilayer formation on the aluminum surface was performed in order to confirm and strengthen the firmness of the bilayer against a severe corrosive acidic environment for a prolonged time of exposure. The inhibition efficiency values in FIG. 3 indicate that maximum inhibition (i.e., ≈100%) was obtained for all the shown reinforced silica gel concentrations of the formed bilayer. This inhibition efficiency realized from FIG. 3 can also be observed through the SEM images of FIGS. 4A-4E. FIGS. 4A-4E show the SEM images of a glutamine-reinforced silica gel bilayer on an aluminum surface after having been exposed to different time intervals of a corrosive molar HCl solution. Apparently, the firmness of the bilayer in FIG. 4A against molar HCl for about one hour is in much better consistency and homogeneity than that of the monolayer in FIG. 2D. The cross-torn cracks in the bilayer have been reduced to about 160-320 nm. This large reduction provides eminent protection and extensive resistance against a corrosive environment. As shown in the SEM image of FIG. 4B, a continual exposure of HCl to the bilayer for about 6 hours did not alter the bilayer features and/or cracks, which provides further evidence on the solidity and consistency of the bilayer against a severe corrosive environment. As shown in the SEM image of FIG. 4D, after the passage of about 24 hours, the cross-torn cracks increased but the cracked micro-islands preserved their skeleton-like appearance. As shown in the SEM image of FIG. 4E, after the passage of about 48 hours, the bilayer is still preserving its skeleton, and no complete destruction or collapse of the bilayer occurred. This provides evidence on the strong intermolecular cohesive and adhesive forces within the bilayer itself and with the aluminum surface, which indicates the superior protection of the monolayer and the bilayer against a severe corrosive environment for a prolonged time period.

Apparently, the absolute value of standard free energy of the adsorption of the anticorrosion film monolayer is in a range of 23-25 kJ/mol, which confirms that the monolayer adsorption on the metal surface is a physical adsorption process. In addition, at 40° C., the ΔS°_{ads} value decreased due to high surface energy that favors desorption of the monolayer (less entropic) and adsorption of water molecules (more entropic) on the metal surface as follows:

Inhibitor's Macromolecules_{(sol.)}+H₂O _{(ads.)}⇄Inhibitor's Macromolecules_{(ads.)}H₂O₍ₛₒₗ₎

The following publication is incorporated by reference herein: M. Fares et al., “Glutamine-reinforced silica gel microassembly as protective coating for aluminium surface,” Materials Chemistry and Physics, Vol. 162, pp. 124-130, Jul. 15, 2015.

While embodiments of the disclosure have been described in detail and with reference to specific embodiments thereof, it will be apparent to one skilled in the art that various additions, omissions, and modifications can be made without departing from the spirit and scope thereof.

Although the above description contains some specificity, these should not be construed as limitations on the scope of the invention, but is merely representative of the disclosed aspects of the present disclosure.

It is contemplated that any embodiment discussed in this specification can be implemented with respect to any method, kit, reagent, or composition of the invention, and vice versa. Furthermore, compositions of the invention can be used to achieve methods of the invention.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. Where a range of numerical values is recited herein, unless otherwise stated, the range is intended to include the endpoints thereof, and all integers and fractions within the range. It is not intended that the scope of the invention be limited to the specific values recited when defining a range. Moreover, all ranges set forth herein are intended to include not only the particular ranges specifically described, but also any combination of values therein, including the minimum and maximum values recited.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, “significance” or “significant” relates to a statistical analysis of the probability that there is a non-random association between two or more entities. To determine whether or not a relationship is “significant” or has “significance,” statistical manipulations of the data can be performed to calculate a probability, expressed as a “p value.” Those p values that fall below a user-defined cutoff point are regarded as significant. In some embodiments, a p value less than or equal to 0.05, in some embodiments less than 0.01, in some embodiments less than 0.005, and in some embodiments less than 0.001, are regarded as significant. Accordingly, a p value greater than or equal to 0.05 is considered not significant.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. An anticorrosion composition, comprising:
an amino acid;
a silica gel;
a glyceryl linkage; and
a multivalent cation, wherein the amino acid is suitable to bind onto a surface of a substrate, the glyceryl linkage binds hydroxyl groups of particles of the silica gel together forming a silica gel cluster, the glyceryl linkage chemically binds carboxyl groups of the amino acid with hydroxyl groups of the silica gel cluster, and the cation physically binds carboxyl groups of the amino acid with hydroxyl groups of the silica gel cluster through ionic bonding.

2. The composition of claim 1, wherein said amino acid comprises glutamine.

3. The composition of claim 2, wherein said composition comprises about 19.0%-50.0% by weight of said glutamine.

4. The composition of claim 1, wherein said composition comprises about 29.0%-48.0% by weight of said silica gel.

5. The composition of claim 1, wherein said composition comprises about 14.0%-24.0% by weight of said glyceryl linkage.

6. The composition of claim 1, wherein said multivalent cation comprises calcium.

7. The composition of claim 6, wherein said composition comprises about 5.0%-10.0% by weight of said calcium cation (Ca⁺⁺).

8. An anticorrosion film comprising a layer of an anticorrosion composition applied to a substrate surface, wherein the anticorrosion composition comprises:
an amino acid;
a silica gel;
a glyceryl linkage; and
a multivalent cation, wherein the amino acid binds onto the substrate surface, the glyceryl linkage binds hydroxyl groups of particles of the silica gel together forming a silica gel cluster, the glyceryl linkage chemically binds carboxyl groups of the amino acid with hydroxyl groups of the silica gel cluster, and the cation physically binds carboxyl groups of the amino acid with hydroxyl groups of the silica gel cluster through ionic bonding.

9. The anticorrosion film of claim 8, wherein said substrate surface comprises a metal surface.

10. The anticorrosion film of claim 8, wherein said substrate surface comprises aluminum.

11. The anticorrosion film of claim 8, wherein said amino acid comprises glutamine.

12. The anticorrosion film of claim 8, wherein said multivalent cation comprises calcium.

13. A method of forming an anticorrosion film on a substrate surface, comprising:
activating the substrate surface;
forming a zwitterion layer on said substrate surface;
preparing a synthesized reinforced silica gel solution; and
covering said zwitterion layer with the synthesized reinforced silica gel solution while adding calcium ions as a crosslinking agent.

14. The method of claim 13, wherein said activation is performed by maintaining the substrate surface in an aqueous solution having a pH of about 10.

15. The method of claim 13, wherein the formation of the zwitterion layer comprises:
dissolving glutamine amino acid in water;
adjusting the pH of the water-glutamine solution to a pH of about 8.5; and
soaking said activated substrate surface in the water-glutamine solution having a pH of about 8.5.

16. The method of claim 13, wherein the preparation of said synthesized reinforced silica gel solution comprises:
dissolving a specific amount of silica gel solution in an aqueous solution having a pH of about 12.5 to prepare a first solution;
adjusting the pH of the first solution to about 10;
dissolving a glyceryl linkage in the first solution; and
dissolving CaCl₂ in the first solution containing the glyceryl linkage.

17. The method of claim 16, wherein the first solution comprises a silica gel concentration ranging between about 300 ppm to 1200 ppm.

18. The method of claim 13, wherein the substrate surface comprises aluminum.

19. The method of claim 13, wherein said activation is performed by maintaining the substrate surface in an aqueous solution having a pH of about 10,
wherein the formation of the zwitterion layer comprises:
dissolving glutamine amino acid in water;
adjusting the pH of the water-glutamine solution to a pH of about 8.5; and
soaking said activated substrate surface in the water-glutamine solution having a pH of about 8.5, and
wherein the preparation of said synthesized reinforced silica gel solution comprises:
dissolving a specific amount of silica gel solution in an aqueous solution having a pH of about 12.5 to prepare a first solution;
adjusting the pH of the first solution to about 10;
dissolving a glyceryl linkage in the first solution; and
dissolving CaCl₂ in the first solution containing the glyceryl linkage.

20. The method of claim 19, wherein said anticorrosion film comprises about 19.0%-50.0% by weight of said glutamine amino acid, about 29.0%-48.0% by weight of said silica gel, about 14.0%-24.0% by weight of said glyceryl linkage, and about 5.0%-10.0% by weight of said calcium ions.
